(19) United States
(12) Patent Application Publication
(10) Pub. No.: US 2017/0348876 A1
(43) Pub. Date: Dec. 7, 2017

(54) THIN PLY HIGH TEMPERATURE COMPOSITES

(71) Applicant: General Electric Company, Schenectady, NY (US)

(72) Inventors: Wendy Wen-Ling Lin, Montgomery, OH (US); Douglas Duane Ward, West Chester, OH (US); James Dale Steibel, Mason, OH (US)

(21) Appl. No.: 15/169,403

(22) Filed: May 31, 2016

(51) Int. Cl. B29B 15/12; B29C 70/54; B29D 99/00; B32B 5/26; B32B 37/00; B29C 35/02; B29C 70/30; B29L 31/30; B29L 31/08; B29K 309/08; B29K 309/02; B29K 305/02; B29K 83/00; B29K 81/00; B29K 79/00

(52) U.S. Cl. CPC B29B 15/127; B29C 70/30; B29C 70/54; B29D 99/0025; B32B 5/26; B32B 37/0038; B29C 35/02; B29L 2031/3076; B29L 2031/08; B29K 2309/08; B29K 2309/02; B29K 2305/02; B29K 2279/08; B29K 2083/00; B29K 2081/00; B29K 2079/085; B32B 2260/021; B32B 2311/24; B32B 2315/02; B32B 2315/08; B32B 2379/08; B32B 2605/18; B32B 2603/00

(57) ABSTRACT

A method of fabricating a laminar composite article, includes steps of spreading a plurality of continuous fiber tows from a spool to form a first ply layer having a substantially consistent layer thickness, applying a binder to the spread plurality of continuous fiber tows, curing the plurality of continuous fiber tows and applied binder at a cure temperature less than a thermal decomposition temperature of the binder, and processing the cured plurality of continuous fiber tows at a post-cure temperature greater than the cure temperature.

### BACKGROUND

The field of the disclosure relates generally to gas turbine engine components, and more particularly, to high temperature composite materials for gas turbine engine components.

In order to increase the efficiency and the performance of gas turbine engines so as to provide increased thrust-to-weight ratios, lower emissions and improved specific fuel consumption, engine components have been made from lighter composite materials able to withstand higher operating temperatures, including ceramic matrix composites (CMCs), which provide an improved temperature and density advantage over most metals. The composite materials are typically made from layers, or plies, of fibrous strands, or tows. The composite plies are first formed into thin sheets (prepreg process), and then the plies are cut into shape, stacked, pressed and laminated together at a higher temperature curing process to create the desired engine component.

During the prepreg process, the tows can tend to clump together especially when trying to create very thin prepregs, even while being spread by machinery. The clumping phenomenon results in the individual plies being thicker and non-uniform. Finished components made from thicker ply materials can experience greater degrees of delamination and micro-cracking at the edges, ply drops, and/or open holes of the components, as the laminated edges are subjected to repeated fatigue loading and tensile stresses. For some low temperature composites, nylon binders have been used to maintain thinner plies during prepreg process. These nylon binders though, melt and degrade at lower temperatures than are required for fabrication of most high temperature (>400° F. process) materials, that is, at about 400° F. or greater. Such high temperature materials include bismaleimides (BMI), polyimides (PI), carbon-carbon, and CMCs such as silicon carbides (SiC) and aluminum oxides (Al₂O₃).

### BRIEF DESCRIPTION

In one aspect, a method of fabricating a laminar composite article, includes steps of spreading a plurality of continuous fiber tows from a spool to form a first ply layer having a substantially consistent layer thickness, applying a binder to the spread plurality of continuous fiber tows, curing the plurality of continuous fiber tows and applied binder at a cure temperature less than a thermal decomposition temperature of the binder, and processing the cured plurality of continuous fiber tows at a post-cure temperature greater than the cure temperature.

In another aspect, a laminar composite article, includes a cured, reinforced matrix of composite material. The matrix includes a plurality of individual ply layers laminated together. Each ply layer of the plurality of individual ply layers includes a plurality of continuous tows extending substantially parallel to each other through the ply layer. Each of the plurality of continuous tows includes a plurality of individual fibers. Each ply layer further includes an average minimum fiber spacing between adjacent ones of the plurality of individual fibers equal to or greater than half of a diameter of the individual fibers.

In yet another aspect, a gas turbine engine includes a combustion section, a cold section forward of the combustion section, and a hot section aft of the combustion section. The hot section includes a laminar composite article fabricated of a cured, reinforced matrix of composite material. The matrix includes a plurality of individual ply layers laminated together. Each ply layer of the plurality of individual ply layers includes a plurality of continuous tows extending substantially parallel to each other through the ply layer. Each of the plurality of continuous tows includes a plurality of individual fibers. Each ply layer further includes an average minimum fiber spacing between adjacent ones of the plurality of individual fibers equal to or greater than half of a diameter of the individual fibers.

### DRAWINGS

These and other features, aspects, and advantages of the present disclosure will become better understood when the following detailed description is read with reference to the accompanying drawings in which like characters represent like parts throughout the drawings, wherein:

FIG. 1 is a schematic illustration of an exemplary gas turbine engine in accordance with an exemplary embodiment of the present disclosure.

FIG. 2 is a perspective illustration of an exemplary composite engine component that can be utilized with the gas turbine engine depicted in FIG. 1.

FIG. 3 is an exploded perspective view illustrating the layered construction of the engine component depicted in FIG. 2.

FIGS. 4A and 4B illustrate partial sectional views of the fiber tows that form the individual ply layers depicted in FIG. 3.

FIGS. 5A-5C illustrate partial sectional views of the thin tow spread of fibers depicted in FIG. 4B, at successive processing steps.

FIG. 6 illustrates a partial sectional view of a woven fiber thin tow spread.

FIG. 7 is a flow chart diagram of an exemplary laminate article manufacturing process.

FIG. 8 illustrates a partial perspective view of an alternative binder application to the fiber tows depicted in FIGS. 4A-4B.

FIG. 9 illustrates a partial perspective view of an alternative binder application to the arrangement depicted in FIG. 8.

FIG. 10 is a schematic illustration of an alternative binder application to the arrangements depicted in FIGS. 8 and 9.

Unless otherwise indicated, the drawings provided herein are meant to illustrate features of embodiments of this disclosure. These features are believed to be applicable in a wide variety of systems including one or more embodiments of this disclosure. As such, the drawings are not meant to include all conventional features known by those of ordinary skill in the art to be required for the practice of the embodiments disclosed herein.

### DETAILED DESCRIPTION

In the following specification and the claims, reference will be made to a number of terms, which shall be defined to have the following meanings.

The singular forms “a,” “an,” and “the” include plural references unless the context clearly dictates otherwise.

“Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about,” “approximately,” and “substantially,” are not to be limited to the precise value specified. In at least some instances, the approximating language may correspond to the precision of an instrument for measuring the value. Here and throughout the specification and claims, range limitations may be combined and/or interchanged; such ranges are identified and include all the sub-ranges contained therein unless context or language indicates otherwise.

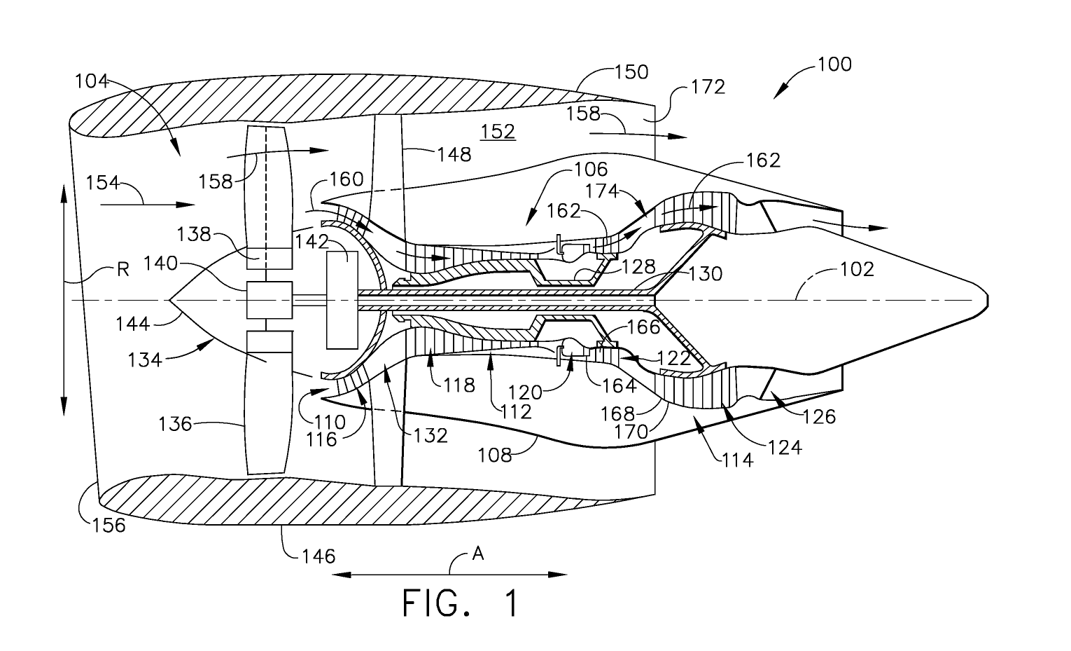

FIG. 1 is a schematic cross-sectional view of a gas turbine engine 100 in accordance with an exemplary embodiment of the present disclosure. In the exemplary embodiment, gas turbine engine 100 is embodied in a high-bypass turbofan jet engine. As shown in FIG. 1, gas turbine engine 100 defines an axial direction A (extending parallel to a longitudinal axis 102 provided for reference) and a radial direction R. In general, gas turbine engine 100 includes a fan section 104 and a core engine 106 disposed downstream from fan section 104.

In the exemplary embodiment, core engine 106 includes an approximately tubular outer casing 108 that defines an annular inlet 110. Outer casing 108 encases, in serial flow relationship, a compressor section 112 and a turbine section 114. Compressor section 112 includes, in serial flow relationship, a low pressure (LP) compressor, or booster, 116, a high pressure (HP) compressor 118, and a combustion section 120. Turbine section 114 includes, in serial flow relationship, a high pressure (HP) turbine 122, a low pressure (LP) turbine 124, and a jet exhaust nozzle section 126. A high pressure (HP) shaft, or spool, 128 drivingly connects HP turbine 122 to HP compressor 118. A low pressure (LP) shaft, or spool, 130 drivingly connects LP turbine 124 to LP compressor 116. Compressor section 112, combustion section 120, turbine section 114, and nozzle section 126 together define a core air flowpath 132. Compressor section 112 is also sometimes referred to as the “cold section,” and turbine section 114 is sometimes referred to as the “hot section.”

In the exemplary embodiment, fan section 104 includes a variable pitch fan 134 having a plurality of fan blades 136 coupled to a disk 138 in a spaced apart relationship. Fan blades 136 extend radially outwardly from disk 138. Each fan blade 136 is rotatable relative to disk 138 about a pitch axis P by virtue of fan blades 136 being operatively coupled to a suitable pitch change mechanism (PCM) 140 configured to vary the pitch of fan blades 136. In other embodiments, PCM 140 is configured to collectively vary the pitch of fan blades 136 in unison. Fan blades 136, disk 138, and PCM 140 are together rotatable about longitudinal axis 102 by LP shaft 130 across a power gear box 142. Power gear box 142 includes a plurality of gears (not shown) for adjusting the rotational speed of variable pitch fan 134 relative to LP shaft 130 to a more efficient rotational fan speed.

Disk 138 is covered by a rotatable front hub 144 that is aerodynamically contoured to promote airflow through fan blades 136. Additionally, fan section 104 includes an annular fan casing, or outer nacelle, 146 that circumferentially surrounds variable pitch fan 134 and/or at least a portion of core engine 106. In the exemplary embodiment, annular fan casing 146 is configured to be supported relative to core engine 106 by a plurality of circumferentially-spaced outlet guide vanes 148. Additionally, a downstream section 150 of annular fan casing 146 may extend over an outer portion of core engine 106 so as to define a bypass airflow passage 152 therebetween.

During operation of gas turbine engine 100, a volume of air 154 enters gas turbine engine 100 through an associated inlet 156 of annular fan casing 146 and/or fan section 104. As volume of air 154 passes across fan blades 136, a first portion 158 of volume of air 154 is directed or routed into bypass airflow passage 152 and a second portion 160 of volume of air 154 is directed or routed into core air flowpath 132, or more specifically into LP compressor 116. A ratio between first portion 158 and second portion 160 is commonly referred to as a bypass ratio. The pressure of second portion 160 is then increased as it is routed through high pressure (HP) compressor 118 and into combustion section 120, where it is mixed with fuel and burned to provide combustion gases 162.

Combustion gases 162 are routed through HP turbine 122 where a portion of thermal and/or kinetic energy from combustion gases 162 is extracted via sequential stages of HP turbine stator vanes 164 that are coupled to outer casing 108 and a plurality of HP turbine rotor blades 166 that are coupled to HP shaft 128, thus causing HP shaft 128 to rotate, which then drives a rotation of HP compressor 118. Combustion gases 162 are then routed through LP turbine 124 where a second portion of thermal and kinetic energy is extracted from combustion gases 162 via sequential stages of a plurality of LP turbine stator vanes 168 that are coupled to outer casing 108, and a plurality of LP turbine rotor blades 170 that are coupled to LP shaft 130 and drive a rotation of LP shaft 130 and LP compressor 116 and/or rotation of variable pitch fan 134.

Combustion gases 162 are subsequently routed through jet exhaust nozzle section 126 of core engine 106 to provide propulsive thrust. Simultaneously, the pressure of first portion 158 is substantially increased as first portion 158 is routed through bypass airflow passage 152 before it is exhausted from a fan nozzle exhaust section 172 of gas turbine engine 100, also providing propulsive thrust. HP turbine 122, LP turbine 124, and jet exhaust nozzle section 126 at least partially define a hot gas path 174 for routing combustion gases 162 through core engine 106. Composite engine components disposed within hot gas path 174, i.e., hot section 114 are required to withstand a considerably greater temperature range than engine components forward of hot gas path 174, i.e., within cold section 112.

Gas turbine engine 100 is depicted in FIG. 1 by way of example only. In other exemplary embodiments, gas turbine engine 100 may have any other suitable configuration including for example, a turboprop engine. Gas turbine engine 100 could also be a steam engine configuration, or an engine requiring lightweight, durable components in a high-temperature dynamic environment.

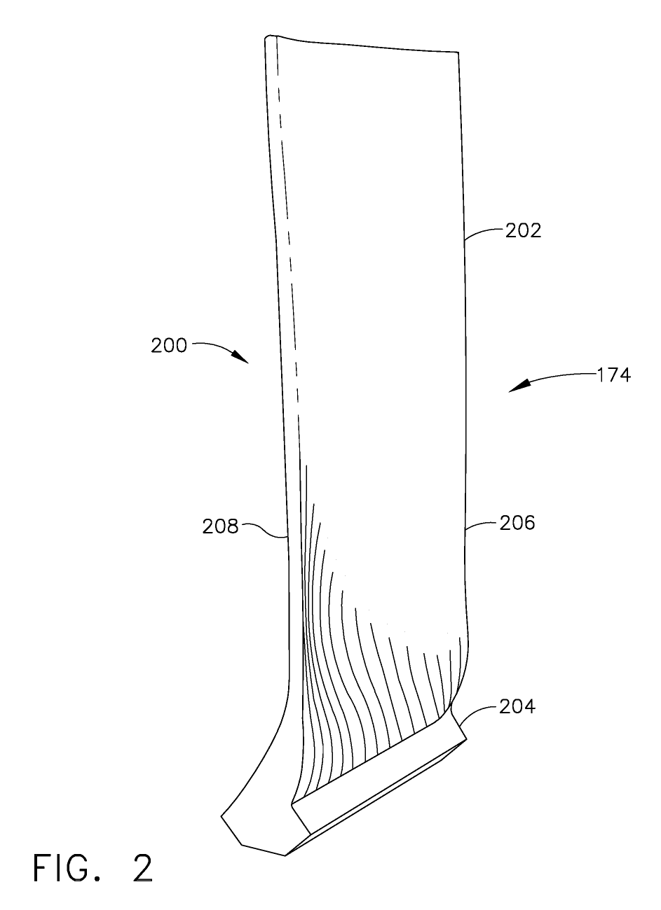

FIG. 2 is a perspective illustration of an exemplary composite engine component that can be utilized with gas turbine engine 100, depicted in FIG. 1. In this example, the engine component is illustrated as an uncoated, i.e., uncooled, airfoil 200. According to the exemplary embodiment, airfoil 200 is formed from a CMC material, such as SiC. In alternative embodiments, airfoil 200 is formed from other high temperature composite materials, such as BMI, SiO, PI, quartz, and aluminum oxide.

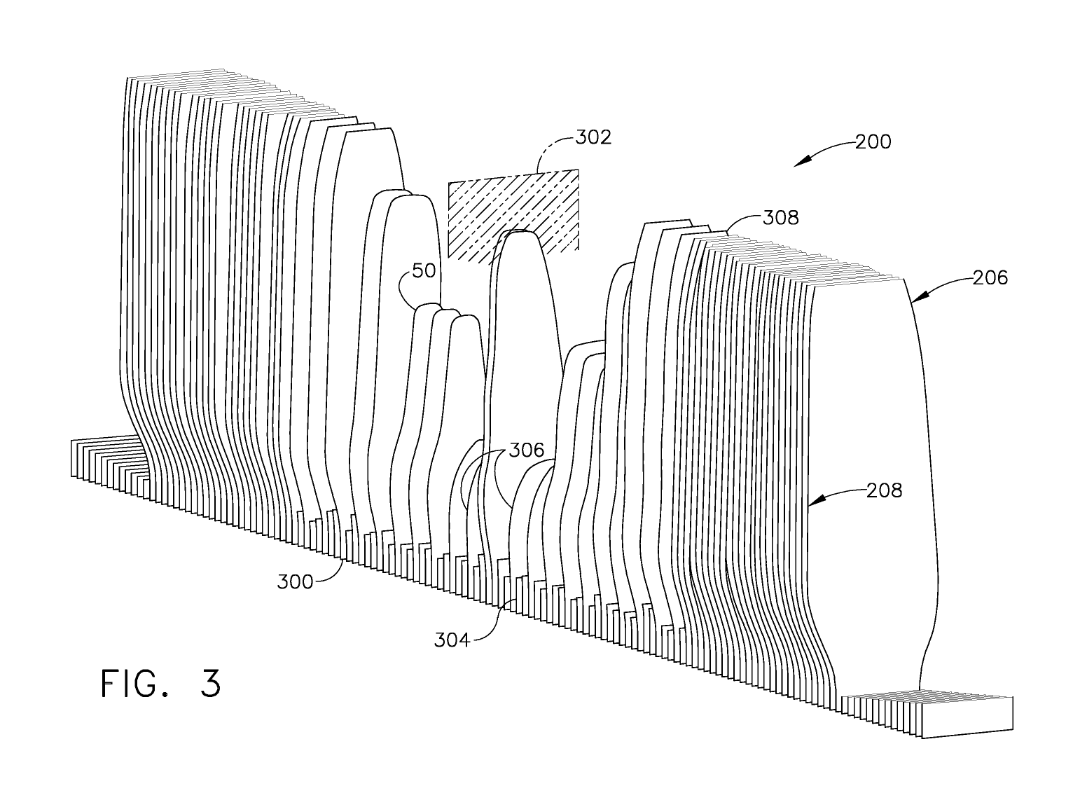

Airfoil 200 includes a forward portion 202 against which a flow of gas is directed, e.g., hot gas path 174. Airfoil 200 is mounted to a disk (not shown) by a dovetail 204 that extends downwardly as viewed in FIG. 2 from forward portion 202 and engages a slot (not shown) of complimentary geometry on the disk. According to the exemplary embodiment, airfoil 200 does not include an integral platform, and a separate platform can be provided to minimize the exposure of dovetail 204 to the surrounding environment, if desired. In alternative embodiments, the complex geometry of airfoil 200 may include an integral platform. Airfoil 200 further includes a leading edge section 206 and a trailing edge section 208. As discussed further below with respect to FIG. 3, the complex geometry of airfoil 200 is fabricated of a plurality of cured, reinforced, high temperature, thin ply composite layers.

FIG. 3 is an exploded perspective view illustrating the layered construction of airfoil 200 depicted in FIG. 2. In an exemplary embodiment, airfoil 200 is fabricated of a plurality of ply layers 300 arranged around a centerplane 302. For the particular geometry of airfoil 200, the layered construction includes a plurality of root plies 304 and short plies 306 arranged between long plies 308. In this example, the smaller plies 304, 306 allow airfoil 200 to have a dovetail geometry when all the plies 304, 306, 308 are laminated together and cured in the layered order shown.

As described herein, the term “fiber” describes a smallest unit of fibrous material, having a high aspect ratio and a diameter that is relatively small in comparison with its length. The term fiber is also used interchangeably with filament. Additionally, a “tow” refers to a bundle of continuous fibers or filaments, and a “matrix” refers to an essentially homogenous material into which other materials, compounds, polymers, fibers, or tows are embedded. In some instances, individual plies are referred to as a “prepreg” layer, which refers to a sheet of unidirectional tow, or short lengths of discontinuous fiber, impregnated with matrix material. Prepreg layers are typically a fabric which has been pre-impregnated with a curing agent, which allows the multiple ply layers to be laminated together and cured in a mold without the addition of further agents. As described herein, a “pre-form” is a lay-up of prepreg plies, which may include additional inserts, into a predetermined shape prior to final curing of the prepreg plies.

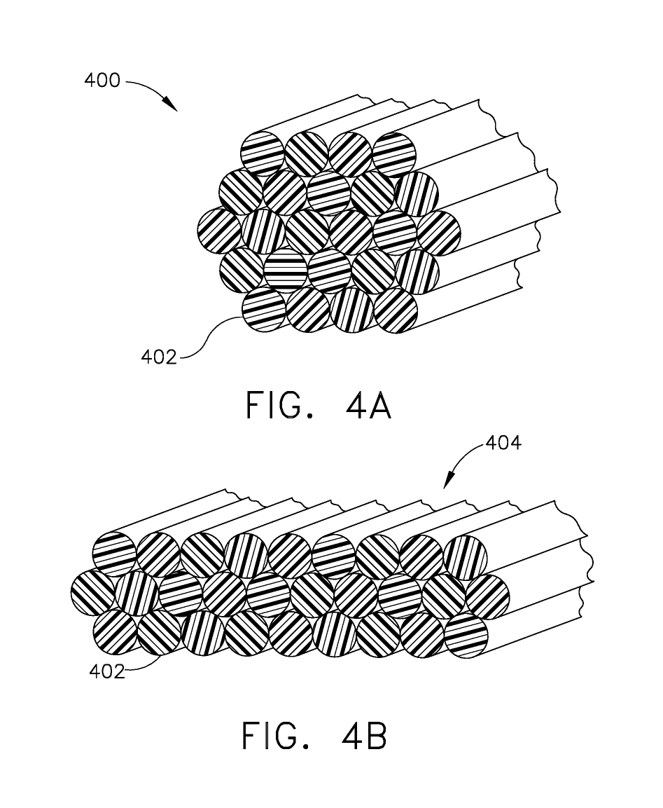

In the exemplary embodiment, each of the plies 304, 306, 308 is fabricated of a flattened layer of fibers or tows of the particular high temperature composite material desired, and each is oriented in a single, predetermined direction for the individual ply, as shown below in FIGS. 4A-4B, described further below. Plies 308 extend the full length or substantially the full length of airfoil 200, and the orientation of each of plies 304, 306, 308 is determined to provide the desired mechanical properties for airfoil 200. Accordingly, a 0° orientation describes a ply that is laid up so that its line of fiber tows is substantially parallel to a preselected plane of the component, for example the long dimension or axis (not shown) of a turbine blade. A 90° orientation describes a ply oriented at substantially 90° to the preselected plane. The remaining plies may be laid up in an altering formation, such as ±45° to the preselected plane of the part. Thus, in the exemplary embodiment, a sequence of ply layers 300 is laid up in a sequence of 0°, +45°, −45°, 90°, 45°, +45°, 0° so that airfoil 200 has tensile strength in directions other than along the airfoil's axis.

In the exemplary embodiment, the composite component is formed of a lay-up of substantially continuous plies, each ply in the lay-up of substantially continuous plies having a plurality of tows extending substantially parallel to each other in an uncured matrix material, each ply being positioned so that the tows extend at a preselected angle to the tows in an adjacent ply. In areas where complex features are present, non-ply ceramic inserts are incorporated into the component, so that the turbine component is a combination of prepreg layers and non-ply ceramic inserts such that the inserts are modeled into the component to replace a substantial number of the small prepreg plies that previously were cut to size to provide for a change in thickness or a change in contour, the replacement of which provides a predetermined shape. The reinforced ceramic matrix composite is then cured to form the article.

The number of continuous fiber thin plies that extend along the substantially full length of the component, e.g., long plies 308, is maximized for structural stability of the laminate, particularly where the plies meet at edges and holes. The thinner ply layers experience less edge/hole microcracking and delamination over time than relatively thicker layers. In some embodiments, inserts are utilized, and a slurry paste or putty can be applied into cavities of the article as the article is laid up, forming an uncured insert, which then cures on drying or subsequent curing processes.

In the exemplary embodiment, the final cured airfoil 200 is a CMC component having tows extending in preselected orientations, and having a majority of plies 300 extending substantially the full length of airfoil 200. Alternatively, airfoil 200 is a component fabricated from a different high temperature material such as CF/BMI, SiO, PI, quartz, or aluminum oxide fibers. In CMCs having a plurality of plies, the cured component yields a plurality of groups of continuous tows, the tows in each group extending substantially parallel to each other in a matrix, each group oriented at a preselected angle to the tows in at least one other group and each group having substantially anisotropic properties. In alternative embodiments, each of ply layers 300 includes a tow of a different predetermined orientation than an immediately adjacent ply in order to maximize strength of the finished laminate, or one or more immediately adjacent ply layers 300 are oriented parallel to one another. In another alternative embodiment, at least one discontinuously reinforced composite insert (not shown) having substantially isotropic properties is incorporated into the component between adjacent ply layers 300. The insert may also extend substantially the length of the component, or may be modeled to replace specially cut, smaller prepreg plies at contours and at changes in discontinuously reinforced composite part thickness.

FIGS. 4A and 4B illustrate partial sectional views of the fiber tows that form the individual ply layers depicted in FIG. 3. In prepreg processing, for example, spools of fiber tows, or yarns, are typically spread over rollers to form a uniform wide tape. The thinness of the spread fiber is limited by the strength of the material and its adhesion. The uniform material can become unstable when spread too thin. FIG. 4A depicts a “thick” tow spread 400 of individual fibers 402 shown clumped, or coalesced, together off of the spool. FIG. 4B depicts a “thin” tow spread 404 of fibers 402 that have been flattened and spread, prior to a curing process, to prepare a fiber pre-form into the desired shape for an individual ply layer, e.g., ply layer 300, FIG. 3.

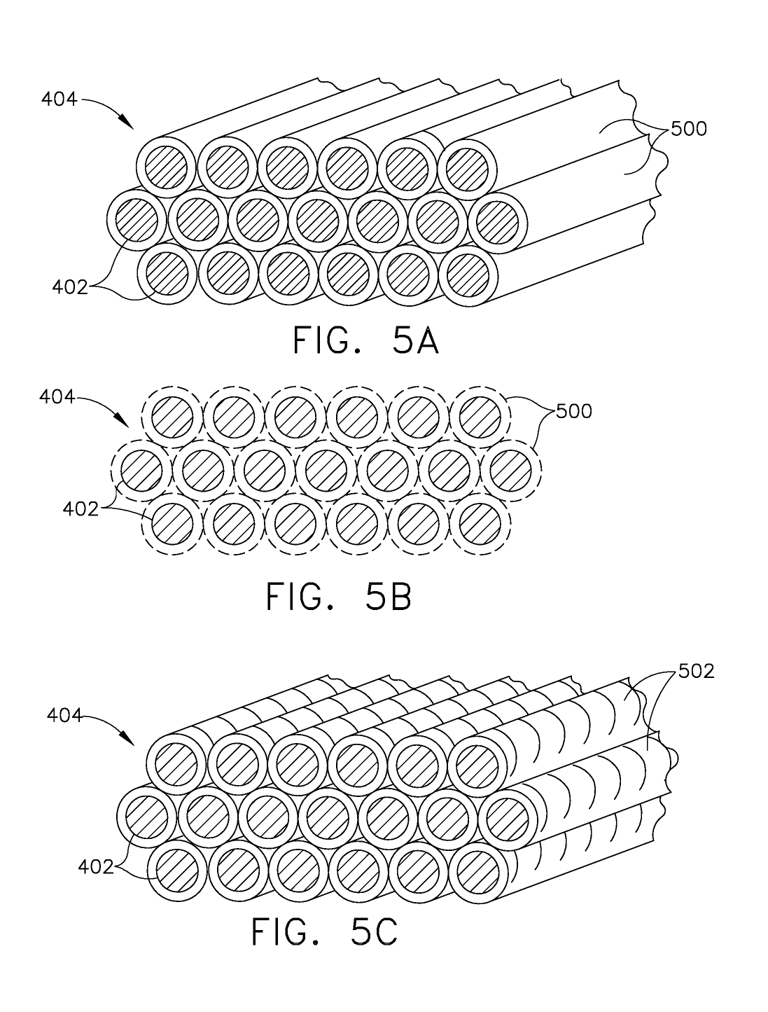

Conventional manufacturers apply chemical sizings to the fibers of spools of fiber tows prior to shipping. The chemical sizings protect the individual fibers during shipment and handling, and are typically burned off prior to or during a fiber coating operation at temperatures exceeding 400° F. With the loss of the chemical sizing, the individual fiber tows tend to coalesce. As described below with respect to FIGS. 5A-5C (for a unidirectional spread) and 6 (for a woven structure), a binder is applied to the fiber tows prior to formation of the finished article to maintain the thin tow spread, i.e., tow spread 404, FIG. 4B, throughout the manufacturing process until the fibers exhibit minimal relative movement during later curing steps.

FIGS. 5A-5C illustrate partial sectional views of the thin tow spread of fibers depicted in FIG. 4B, at successive processing steps. CMC manufacture, for example, typically require steps of: (1) preparing the fibers for coating deposition and/or sizing removal; (2) applying a fiber coating; and (3) infiltration of a matrix material. Step (2) may be optionally removed for PMC materials. Conventionally, the mechanical spreading of fiber tows into thin ply layers renders such thin plies difficult to handle during manufacturing of the finished component (e.g., airfoil 200), even with automated equipment. Thin ply layers that do not have sufficient strength, i.e., flexibility, and adhesion can wrinkle during manufacturing, or experience other defects that can negatively affect the mechanical properties of the article or lead to ply separation. The present embodiments realize significantly thinner ply layers than conventional fabrication processes, yet maintain strength and adhesion through successive curing processes such that the finished component achieves greater durability in the thermodynamically robust environment of the hot section of a gas turbine engine.

FIG. 5A depicts thin tow spread 404 after an application of a binder 500, prior to fiber coating deposition on thin tow spread 404, such as during an autoclave cycle. In an exemplary embodiment, fiber coalescence is inhibited during curing by application of binder 500 having a thermal decomposition point greater than that of the curing temperature. Where chemical sizing, e.g., polyvinyl alcohol, is applied to the fiber tows prior to shipping, binder 500 may be applied over the chemical sizing as well as the fiber. In the exemplary embodiment, the polyvinyl alcohol decomposes during the fiber coating deposition process, or other high temperature processes if an intermediate fiber coating is not deposited. Curing is performed at temperature ranges between 300 and 400° F.

In the exemplary embodiment, binder 500 is applied using a solution-based process prior to subsequent processing such as chemical vapor deposition (CVD) or chemical vapor infiltration (CVI), which are employed to deposit a fiber coating 502 on fibers 402, as shown in FIG. 5C, below, prior to introducing a matrix material (not shown). Referring back to FIG. 5A, in an alternative embodiment, curing may be performed prior to fiber coating deposition as two polymer application substeps. In the first polymer application substep, binder 500 is applied to fibers 402 by spraying or drawing fibers 402 through a solution containing binder 500. Thin tow spread 500 is subsequently dried prior to subsequent processing in fiber coaters. The second polymer application substep introduces a polymer to the dried binder/spread 500/404 in a solution-based process, described further below. In an exemplary embodiment, the second polymer application substep draws the fibers 402, coated with dried binder 500, through a matrix solution to form a prepreg ply, prior to lay up.

FIG. 5B depicts thin tow spread 404 at an intermediate stage during the CVD/CVI process. For a CMC material, an SiC fiber pre-form is exposed to a gas mixture at standard pressure and a temperature above 1800° F. The gas decomposes, depositing a material, such as boron nitride (BN), as fiber coating 502, i.e., FIG. 5C, below, on and between fibers 402. The temperature of the deposition/infiltration process is such that binder 500 thermally decomposes fully prior to the deposition of fiber coating 502 on fibers 402. In the exemplary embodiment, binder 500 is polyethylene oxide, which has a melting point around 150° F. but a thermal decomposition point around 800° F. This relatively low melting point renders polyethylene oxide convenient to apply prior to or during curing, and allows the fiber pre-form, e.g., tow spread 404, to maintain the desired spacing between individual fibers 402 during subsequent CVI/CVD processing, as shown in FIG. 5B. Polyethylene oxide as binder 500 would thus be substantially removed entirely from a CMC material.

Binder 500 serves to fill the spaces between individual fibers 402 during the higher temperature processing to inhibit fibers 402 from clumping back together, but can be fully removed, as depicted in FIG. 5B, by thermal decomposition during the same higher temperature processing. In the exemplary embodiment, removal of binder 500 (FIG. 5B) and deposition of fiber coating 502 (FIG. 5C) occur during the same first CVI/CVD high-temperature processing step. Alternatively, binder decomposition and fiber coating deposition can be arranged in successive heat zones. Tow spread 404 may be pulled, e.g., off of spools, through a continuous CVD reactor vessel, and binder 500 is thermally removed as tow spread 404 enters the CVD chamber (not shown). Fiber spacing is maintained by holding tow spread 404 under tension while binder 500 is thermally decomposed and replaced by fiber coating 502.

In an alternative embodiment, non-carbide materials, such as silicon oxide, glass, and aluminum fibers, may not employ a fiber coating on individual fibers prior to matrix densification processing. In this alternative, a matrix-compatible binder is utilized similar to the processing described above, except that binder 500 thermally decomposes at a temperature greater than the curing temperature, but less than the temperature of matrix densification, which may be 2000° F. or greater. In this alternative, binder 500 is selected such that it exhibits no/low char to avoid leaving gaps in the matrix from the thermally decomposed binder.

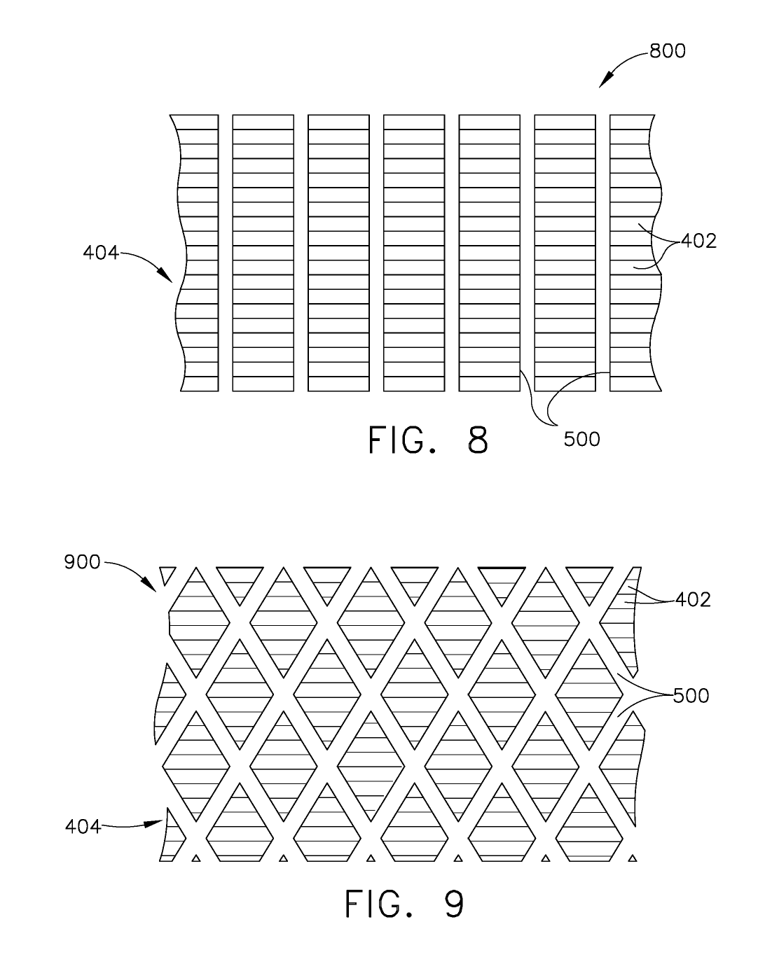

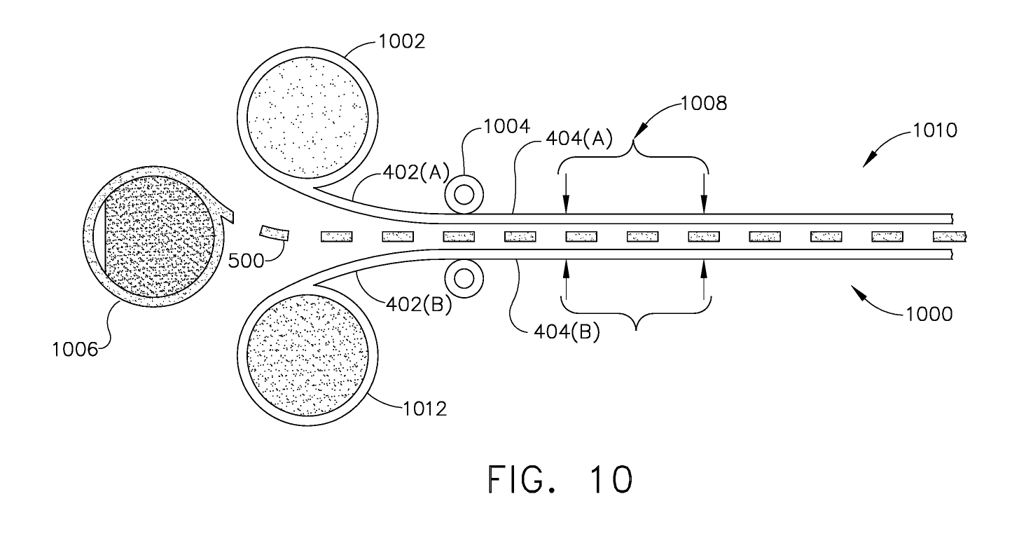

In the exemplary embodiment, binder 500 is a polymer, e.g., polyethylene oxide, that remains thermally stable during, i.e., withstand, a consolidation process, such as which occurs in an autoclave cycle, e.g., below 400° F. For PMC materials, binder 500 may remain thermally stable throughout the entire manufacturing process of the finished article after the consolidation process. For CMC materials, binder 500 is selected such that binder 500 will thermally decompose during a fiber coating deposition process, or for CMC materials that do not incorporate fiber coatings, during subsequent pyrolysis or higher temperature processing steps after the consolidation process. In the embodiment illustrated in FIG. 5A, binder 500 may be applied by spraying fibers 402, or by drawing fibers 402 through a solution containing binder 500. Alternatively, binder 500 is applied to tow spread 404 by over-winding a grid of fibers 402 with binder 500 and melting binder 500 on the grid to tack the tows together, as described further below with respect to FIGS. 8 and 9.

In an alternative embodiment, binder 500 is a polymer exhibiting higher temperature characteristics, such as polysilazane or polycarbosilane, which do not vaporize at high temperatures, but instead may form ceramic materials such as silicon nitride, silicon carbide, and carbon when exposed to temperatures ranging from about 1300° F. through 2200° F. In such alternative embodiments, the binder material is selected such that binder 500 does not decompose during high temperature processing steps, but instead integrally mates with the high-temperature matrix material with which it is compatible. In an example of this alternative embodiment, oxide fibers are prepared with an oxide binder that exhibit similar temperature characteristics to one another.

Conventional CMC components fabricated from SiC matrix composites containing fibrous material infiltrated with molten silicon, sometimes known as the Silcomp process, have been limited to ply layers greater than about 0.013 inches, or 13 mils, for woven CMC articles, and greater than 0.008 inches, or 8 mils, for unidirectional tapes. Finished component shapes from such thicker ply materials, utilizing a minimum of three plies together, are thus typically limited to thicknesses of approximately 0.039 inches, or 39 mils, for woven materials, and 0.025 inches, or 25 mils, for unidirectional materials. Similar thickness limitations have been experienced with standard prepreg plies, which normally have an uncured thickness in the range of about 0.009 inch to about 0.011 inch. Finished articles according to the embodiments described above though, are able to reduce the thickness of the finished ply layers by up to several mils per layer, which result in finished articles having much greater durability.

Thin ply layers have been achieved for conventional carbon fiber articles, but these articles are not generally utilized in thermodynamic environments exceeding 600-650° F. In contrast, the embodiments described herein achieve comparable thin ply laminates capable of withstanding significantly higher temperatures. For example, glass fibers such as SiO and quartz are useful in environments of about 900° F. Aluminum oxide articles are used up to 1800° F. CMC materials such as SiC are utilized for temperatures exceeding 2000-2400° F.

These finished plies use thin, unidirectional tows, allowing initial ply thicknesses of less than 10 mils, generally from 7 mils to 9 mils, depending on the material being laminated. Higher temperature materials generally result in thicker final ply layers after curing than do lower temperature materials, particularly where stiffer fiber materials and fiber coatings are utilized. According to the advantageous embodiments described herein, finished CMC and oxide ply layers survive higher temperature post processing and achieve a thickness less than about 11-13 mils for woven materials, and less than about 7-8 mils for unidirectional materials utilizing the CVI and PIP processes described above. Similarly, BMI and PI layers, as well as phthalonitrile ply composites, according to the present embodiments can be successfully realized at thicknesses ranging from 2-3 mils.

Thinner plies are difficult to handle during manufacturing and fabrication of the finished article. Accordingly, the plies can be best accommodated by the manufacturing process when the plies, or at least a substantial majority thereof, are full length plies that are laid up against a full length insert. Nevertheless, the high-temperature plies fabricated according to the embodiments herein experienced significantly greater durability even prior to lamination into the finished article.

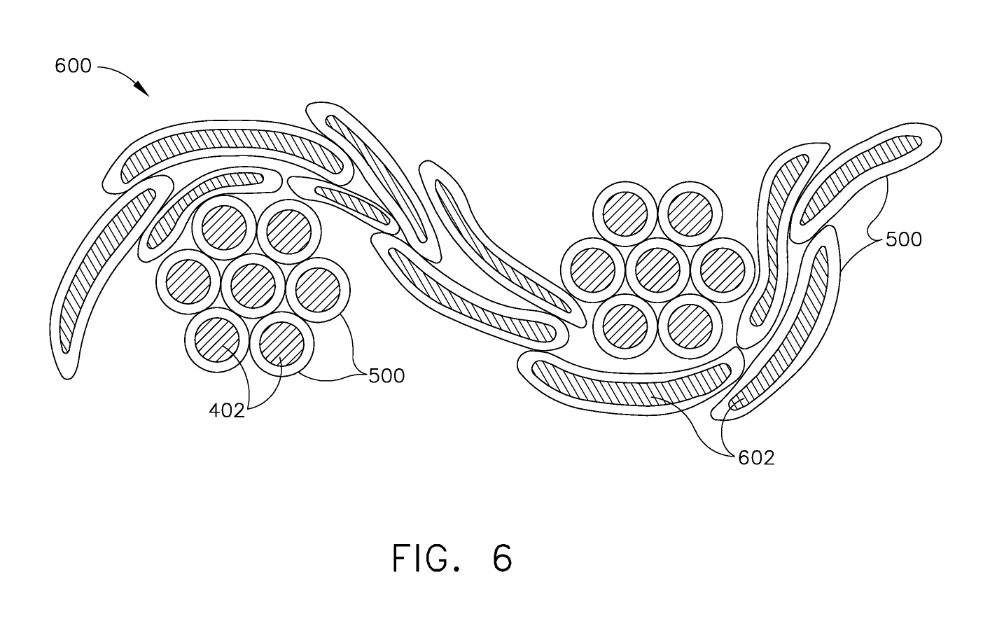

FIG. 6 illustrates a partial sectional view of a woven fiber tow spread 600. Woven fiber tow spread 600 includes fibers 402 woven together with cross fibers 602 in a warp and fill pattern, prior to formation into a thin ply layer, e.g., ply layer 300, FIG. 3. In the exemplary embodiment, binder 500 is applied to fibers 402 and cross fibers 602 prior to weaving in order to inhibit damage to the individual fibers during the weaving process. For woven fiber tow spread 600, each “thread” is a single tow of fibers containing a plurality of individual fiber filaments 402 and 602. The woven “fabric” is then shaped into a pre-form, and layers of individual woven plies are cut into final shapes formed on a tool or mandrel. The resultant pre-form shape may then be held in a clamping tool in the CVI/CVD reactor during fiber coating deposition (or other matrix densification), and then processed similarly to the non-woven, unidirectional embodiments described above with respect to FIGS. 5A-5C.

Specifically, woven fiber tow spread 600 includes binder 500 selected to be compatible with a matrix material subsequently introduced to the pre-form. Similar to the embodiments described above, woven fiber tow spread 600 utilizes binder 500 that may exhibit a relatively lower temperature characteristics such that clumping of fibers 402 and 602 is inhibited during a curing step, and is substantially decomposed and removed by CVI/CVD processes that introduce a fiber coating, e.g., fiber coating 502, or matrix phase introduction, as described above for CMC articles.

The article resulting from a first CVI/CVD process will exhibit significant porosity with respect to fiber coating 502. Nevertheless, a sufficient quantity of fiber coating 502 is deposited during this first deposition/infiltration process to hold the fibers 402, 602 together in the desired woven fiber tow spread 600. Resultant porosity of the article from the CVI/CVD process is reduced by subsequent infiltrations/depositions, and the article can then be infiltrated by the matrix material. Fiber coating 502 thus holds the desired fiber spacing between fibers 402, 602 throughout later processing due to the fact that the thickness of fiber coating 502 builds and bridges adjacent fibers to lock them in place, irrespective of subsequent final matrix densification or deposition steps. According to this embodiment, a minimum fiber spacing can be maintained between generally all fibers in the structure, thereby significantly strengthening the finished article, while also allowing for thinner woven structures.

Conventional woven structures exhibit significant numbers of fibers in direct contact with one another, and particularly where fibers and cross fibers meet in the weave. By utilizing the binder materials disclosed herein, the present embodiments are capable of maintaining a minimum fiber spacing between all fibers, thereby allowing for a reduction in the overall thickness of the material without sacrificing strength or durability of the finished article. In the exemplary embodiment, an average minimum fiber spacing between individual fibers 402, 602 is greater than half the fiber diameter.

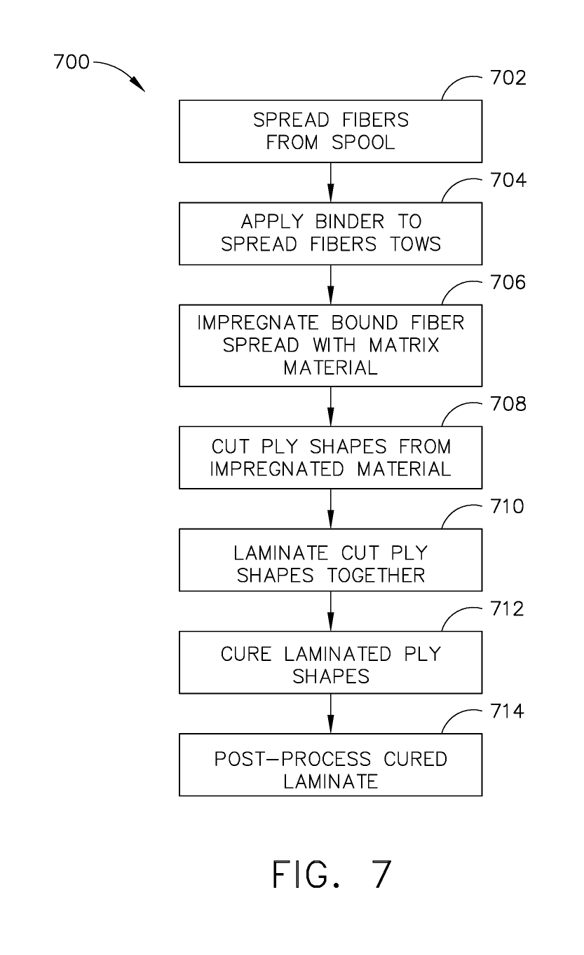

FIG. 7 is a flow chart diagram of a laminate article manufacturing process 700 that may be implemented with the above-described embodiments. Process 700 begins at step 702. In step 702, fibers 402 are spread as they are unwound from the spool (not shown), and then maintained as thin tow spread 404, FIG. 4B. Process 700 then proceeds to step 704, in which binder 500 is applied to mechanically-held tow spread 404, as shown in FIG. 5A, described above. Binder 500 then functions to physically maintain the relative spread of fibers 402 as thin tow spread 404 moves through additional processing steps where the original mechanical maintenance structures do not follow. For CMC materials, step 704 optionally includes a second substep of depositing fiber coating 502 while removing binder 500, as described above with respect to FIGS. 5A-5C. Once bound by binder 500 (for PMC materials and CMC materials not utilizing fiber coatings) or fiber coating 502 (for CMC materials), process 700 proceeds to step 706, in which thin tow spread 404 is impregnated with matrix material to create prepreg plies.

Once prepreg plies are formed, process 700 continues similarly to the processing steps described above with respect to FIG. 3. In step 708, the prepreg plies are cut into shapes, e.g., plies 304, 306, 308, FIG. 3. Step 710 is a consolidation step. In step 710, the cut ply shapes are stacked and laminated together into the desired shape of the finished article, e.g., article 200, FIGS. 2-3. The laminated article is then cured in step 712, and then post-processed, sometimes referred to as “post-cured”, in step 714. Post-processing step 714 is performed at a significantly higher temperature than curing step 712. For example, where the composite material is BMI, curing step 712 is performed at approximately 350-375° F., whereas post-processing step 714 is performed at temperatures of approximately 450° F. or greater. PI, on the other hand, is cured at temperatures exceeding 600-700° F. CMC materials can be cured at even higher temperatures. In an exemplary embodiment, steps 710 and 712 are performed together.

FIG. 8 illustrates a partial perspective view of an alternative binder application 800 to thin tow spread 404. In this embodiment, binder 500 is applied to thin tow spread 404 by over-winding the generally linear fibers 402 with a substantially linear distribution of binder 500 in a direction substantially parallel to the direction of fibers 402. Binder 500 can then be melted on thin tow spread 404 to tack fibers 402 together during subsequent processing steps. For PMC materials, binder 500 is selected of a material that is compatible with the material of fibers 402 such that binder 500 will adhere to the matrix and not degrade during further processing steps. Binder 500 may thus exhibit a relatively higher temperature characteristic, and/or be of a compatible material, such that binder 500 is integrated into the composite matrix material of the finished article. In this example, binder 500 may remain in the finished composite article, e.g., article 200, FIGS. 2-3. Materials for binder 500 in this example may include thermoplastic polyimide, polyphenylsulfone, or polysilazane.

FIG. 9 illustrates a partial perspective view of an alternative binder application 900 to thin tow spread 404. In this embodiment, binder 500 is applied to thin tow spread 404 by over-winding the generally linear fibers 402 in a planar cross-weave distribution. The direction of individual linear portions of the binder in the cross-weave pattern should be oblique to the linear direction of fibers 402 to further inhibit fiber clumping in more than one direction. Similar to the embodiment described with respect to FIG. 8, binder 500 can then be melted on thin tow spread 404 to tack fibers 402 together during subsequent processing steps.

FIG. 10 is a schematic illustration of an alternative binder application 1000. In this embodiment, first fibers 402(A) are fed from a first fiber spool 1002 and through rollers 1004 to mechanically spread first fibers 402(A) into first tow spread 404(A). Simultaneously, binder 500 is fed from binder spool 1006, also through rollers 1004, to create a binder underlayer on a surface (not numbered) of first tow spread 404(A). In this embodiment, binder 500 is a thermally activated adhesive web material applied to the undersurface of first tow spread 404(A), and the combined first tow spread 404(A)/binder 500 is subjected to heat and pressure 1008 to create a composite bound spread 1010 for further processing.

In an alternative embodiment, second fibers 402(B) are fed from a second fiber spool 1012 simultaneously with first fibers 402(A) and binder 500, through rollers 1004, and on a surface (not numbered) of the web of binder 500 opposite to first fibers 402(A). Rollers 1004 thus function to also mechanically spread second fibers 402(B) into second tow spread 404(B), which, upon application of heat and pressure 1008, results in composite bound spread being formed of two thin tow spreads sandwiching binder 500 therebetween.

Thin ply layers having fibers spaced according to the embodiments described above yield additional advantages over the conventional thicker ply materials where most adjacent filaments are in direct contact with one another. Increased fiber density in a thicker ply material, such as a fiber volume of 40%, for example, may exhibit greater in-plane strength, yet experience lower structural efficiency. Lower structural efficiency can result from difficulties in infiltrating matrix material to maximize the material density, or minimize residual matrix porosity. In the exemplary embodiment, fibers 402 are approximately 10-15 microns in diameter, for silicon carbide fibers. At a fiber volume of 25%, spacing between individual fibers within a finished article can be maintained on the order of a fiber diameter, or as low as approximately a 10 microns gap on average. For PMC fibers having average diameters of 5-7 microns, fiber volume is approximately 55%.

Thin ply composite articles formed according the embodiments herein also realize significantly greater uniformity of spacing between individual fibers in the finished article than are seen in conventional composite articles. Conventional processes do not sufficiently control the uniformity of spacing within an individual ply layer, which can further result in reduced durability of the finished article. Protective sizings applied to conventional fiber spools do not provide sufficient fiber spreading control to result in consistent uniformity of spacing in a thin ply layer. Thin ply layers according to the present embodiments are capable of maintaining uniformity of fiber spacing with an average deviation within 0.0005 inches, or a half mil, where the average maximum fiber spacing is a function of the fiber diameter.

The present embodiments have been described with respect to an airfoil section of a narrow chord turbine blade. However, the present embodiments are not limited to only this particular use, but they also can be readily adapted to other hot section components, such as liners, vanes, ducts, cases, external articles, center bodies, and the like, as well as other sections of complex geometries in the hot section of a gas turbine engine, such as platforms and dovetails, in which small multiple plies are cut to size to account for a contour change or a thickness change, particularly over a short distance.

Exemplary embodiments of high temperature, thin ply composite material components for gas turbine engines are described above in detail. The components and methods of fabricating such components are not limited to the specific embodiments described herein, but rather, the components and/or steps of their fabrication may be utilized independently and separately from other components and/or steps described herein. Additionally, the exemplary embodiments can be implemented and utilized in connection with many other engine types that utilize high temperature, light weight components.

This written description uses examples to disclose the embodiments, including the best mode, and also to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

Although specific features of various embodiments of the disclosure may be shown in some drawings and not in others, this is for convenience only. In accordance with the principles of the disclosure, any feature of a drawing may be referenced and/or claimed in combination with any feature of any other drawing.

This written description uses examples to disclose the embodiments, including the best mode, and also to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A method of fabricating a laminar composite article, comprising:
spreading a plurality of continuous fiber tows from a spool to form a first ply layer having a substantially consistent layer thickness;
applying a binder to the spread plurality of continuous fiber tows;
curing the plurality of continuous fiber tows and applied binder at a cure temperature less than a thermal decomposition temperature of the binder; and
processing the cured plurality of continuous fiber tows at a post-cure temperature greater than the cure temperature.

2. The method of claim 1, wherein the plurality of continuous tows comprises one of glass fiber, aluminum oxide, bismaleimide, polyimide, and a ceramic matrix composite.

3. The method of claim 1, wherein the binder comprises one of polyethylene oxide, aluminum oxide, silicon carbide, polysilazane, polycarbosilane, thermoplastic polyimide, and polyphenolsulfane.

4. The method of claim 1, wherein the step of applying the binder is performed by one of spraying the plurality of continuous fiber tows and drawing the plurality of continuous fiber tows through a solution.

5. The method of claim 4, further comprising, after the step of applying the binder and prior to the step of processing, a step of depositing a fiber coating on the cured plurality of continuous fiber tows.

6. The method of claim 1, wherein the binder thermally decomposes during the step of processing.

7. The method of claim 1, wherein the step of applying the binder is performed by melting the binder to tack together the plurality of continuous fiber tows.

8. The method of claim 7, wherein at least a portion of the binder remains in the laminar composite article after the step of processing.

9. The method of claim 1, wherein the cure temperature is greater than a melting point of the binder.

10. A laminar composite article, comprising:
a cured, reinforced matrix of composite material, said matrix comprising a plurality of individual ply layers laminated together, each ply layer of said plurality of individual ply layers comprising:
a plurality of continuous tows extending substantially parallel to each other through said ply layer, each of said plurality of continuous tows including a plurality of individual fibers; and
an average minimum fiber spacing between adjacent ones of said plurality of individual fibers equal to or greater than half of a diameter of the individual fibers.

11. The laminar composite article of claim 10, wherein said composite material comprises aluminum oxide.

12. The laminar composite article of claim 11, wherein said binder comprises aluminum oxide.

13. The laminar composite article of claim 10, wherein said average gap spacing is greater than 10 microns.

14. The laminar composite article of claim 10, wherein said composite material comprises a ceramic matrix composite.

15. The laminar composite article of claim 14, further comprising a plurality of woven tows extending perpendicular to said plurality of continuous tows.

16. The laminar composite article of claim 15, wherein said cured ply layer thickness is less than or equal to 0.013 inches.

17. The laminar composite article of claim 16, wherein said cured ply layer thickness is less than or equal to 0.011 inches.

18. The laminar composite article of claim 14, wherein said binder comprises one of silicon carbide, polysilazane, and polycarbosilane.

19. A gas turbine engine comprising:
a combustion section;
a cold section forward of said combustion section; and
a hot section aft of said combustion section, said hot section including at least one laminar composite article, comprising:
a cured, reinforced matrix of composite material, said matrix comprising a plurality of individual ply layers laminated together, each ply layer of said individual ply layers comprising:
a plurality of continuous tows extending substantially parallel to each other through said ply layer, each of said plurality of continuous tows including a plurality of individual fibers; and
an average minimum fiber spacing between adjacent ones of said plurality of individual fibers equal to or greater than half of a diameter of the individual fibers.

20. The gas turbine engine of claim 19, wherein said at least one laminar composite article is one of an airfoil, a liner, a vane, a duct, a case, and a center body.
